(19) United States
(12) Patent Application Publication
(10) Pub. No.: US 2010/0310124 A1
(43) Pub. Date: Dec. 9, 2010

(54) METHOD OF AND DEVICE FOR DETERMINING THE DISTANCE BETWEEN AN INTEGRATED CIRCUIT AND A SUBSTRATE

(75) Inventors: Christian Zenz, Graz (AT); Dietmar Nessmann, Graz (AT); Shafqat Hussain, Gratkorn (AT); Martin Weinberger, Graz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/744,939

(22) PCT Filed: Nov. 25, 2008
(86) PCT No.: PCT/IB2008/054943

§ 371 Date: May 27, 2010

(30) Foreign Application Priority Data
Nov. 29, 2007 (EP) 07121879.6

(51) Int. Cl. G06K 9/00

(52) U.S. Cl. 382/103

(57) ABSTRACT

In a method of determining the distance (d) between an integrated circuit (1) and a substrate (2) a picture (31,32) of the integrated circuit (1) is taken. The integrated circuit (1) is attached to the substrate (2) that is at least semi transparent. An at least semi transparent material, particularly an at least semi transparent adhesive (8), is located between the integrated circuit (1) and the substrate (2). The picture (31,32) of the integrated circuit (1) is taken through the substrate (2) and the material (8). The picture (31,32) and/or image data related to the picture (31,32) is evaluated and the distance (d) between the integrated circuit (1) and the substrate (2) is determined in response to the evaluated picture (31,32) and/or image data related to the picture (31,32).

### FIELD OF THE INVENTION

The invention relates to a method and to a device for determining the distance between an integrated circuit and a substrate.

### BACKGROUND OF THE INVENTION

Flip chip technology for manufacturing electronic devices is well known in prior art. Here an integrated circuit, which is also referred to as a chip, is mounted to a substrate such that connecting bumps of the integrated circuit electrically contact contacts of the substrate. In order to accomplish contact between the bumps and the substrate contacts, the integrated circuit is pressed against the substrate and heated such that the bumps partly penetrate the substrate contacts and an adhesive between the substrate and the integrated circuit cures. The tool used for pressing the integrated circuit to the substrate and applying heat is usually referred to as a thermode.

Since the parameters of the mounting process, e.g. heat, pressure, the properties of the integrated circuits, the substrate, the adhesive, etc. the distance between the substrate and the integrated circuit is relatively hard to control. Because several integrated circuits are normally mounted simultaneously to their substrates utilizing a plurality of thermodes, controlling said distance (for all integrated circuits) is even more problematic. Moreover, usually a thin layer of paper for avoiding contamination of the thermodes by the adhesive is fed between the thermodes and the integrated circuits. Unfortunately, this paper also influences the manufacturing process in a way, which is hard to predict.

### OBJECT AND SUMMARY OF THE INVENTION

It is an object of the present invention to provide a method to determine the distance between an integrated circuit and a substrate.

A further object of the invention is to provide a device for determining the distance between an integrated circuit and a substrate.

The object is achieved in accordance with the invention by means of a method of determining the distance between an integrated circuit and a substrate, comprising the steps of:

taking a picture of an integrated circuit which is attached to an at least semi transparent substrate, wherein an at least semi transparent material, particularly an at least semi transparent adhesive, is located between the integrated circuit and the substrate, and wherein the picture of the integrated circuit is taken through the substrate and the material;

evaluating the picture and/or image data related to the picture; and

determining the distance between the integrated circuit and the substrate in response to the evaluated picture and/or image data related to the picture.

The object is also achieved in accordance with the invention by means of a device for determining the distance between an integrated circuit and a substrate, comprising a camera and evaluating means configured to evaluate a picture and/or image data related to the picture, wherein the picture is taken by the camera and is a picture of an integrated circuit which is attached to an at least semi transparent substrate, wherein an at least semi transparent material, particularly an at least semi transparent adhesive, is located between the integrated circuit and the substrate, wherein the picture of the integrated circuit is taken through the substrate and the material, and wherein the evaluating means are configured to determine the distance between the integrated circuit and the substrate in response to the evaluated picture and/or image data related to the picture.

The inventive device can be used to perform the inventive method. The inventive device and the inventive method, respectively, are meant for determining the distance between the integrated circuit and the substrate. The integrated circuit may be attached to the substrate particularly by means of the at least semi transparent adhesive. Suitable adhesives are, for instance, non conductive pastes (NCP) or anisotropic conductive pastes (ACP) which may also comprise small conductive particles. Other useful adhesives may, for instance, be non conductive adhesives (NCA), non conductive foils (NCF), anisotropic conductive adhesives (ACA), or anisotropic conductive foils (ACF). Like the adhesive (generally the at least semi transparent material) the substrate is also at least semi transparent. An example of a semi transparent substrate is a relatively thin plastic foil made, for instance, from Polyethyleneterephthalate (PET).

The purpose of attaching the integrated circuit to the substrate is, for instance, to connect contacts of the integrated circuit, such as bumps, to electric contacts of the substrate. In order to determine the distance between the substrate and the integrated circuit, the picture of the integrated circuit, particularly a picture of the integrated circuit surface facing towards the substrate is taken, for instance, with a camera. In this context, a camera is a device configured to capture and potentially store pictures. The picture may particularly be a digital picture or image data related to the picture. Cameras in this context include, without prejudice, CCD-sensors, photo detectors, etc.

The substrate and the material are at least semi transparent. As a result, the integrated circuit, particularly structures of the integrated circuits shine through the material and the substrate and are thus visible in the picture. Especially the material absorbs and/or scatters light. The amount of absorption for an optical layer can at least theoretically be calculated by the so-called Lambert law:

I=I₀e^{-ad}

wherein I₀ is the intensity of light entering the optical layer, I is the intensity of light leaving the optical layer, d is the thickness of the optical layer, and α is the absorption coefficient describing the amount of light the optical layer is absorbing.

As a result, structures of the integrated circuit, particularly the contrast of these structures shown in the picture depend on the thickness of the material and thus on the distance between the integrated circuit and the substrate. Therefore, by evaluating the picture of the integrated circuit and/or the image data related to this picture, particularly by evaluating the contrast of structures shown in the picture by, for instance, means of pattern recognition enables determining the distance between the substrate and the integrated circuit. The better the visibility (i.e. the higher the contrast) of the structures of the integrated circuit in the picture, the smaller the distance between the integrated circuit and the substrate.

If the integrated circuit surface facing towards the substrate is not sufficiently structured, this surface and/or a layer beneath this surface may be provided with additional structures designed for the inventive purpose.

The inventive method and/or the inventive device may be used to determine the distance between the substrate and the integrated circuit after the end of the attachment process for, for instance, checking the correct course of the attachment process. Preferably, the evaluation of the picture and/or image data related to the picture may be carried out automatically. The picture, however, may also be evaluated manually. In response to the determined distance, the attachment process can be adjusted by, for instance, modifying process parameters.

In one embodiment, the determined distance may be used to control the process of connecting the integrated circuit to the substrate in response to the determined distance during the attachment process, particularly such that the distance between the integrated circuit and the substrate has a pre-determined distance at the end of the process. Then, the inventive device may comprise a control device for this control step. It is therefore possible to control the attachment process of the integrated circuit to the substrate in a relative simple manner such that at the end of the attachment process the integrated circuit has the pre-determined distance to the substrate. Thus, a parasitic capacitance dependent on the distance between the substrate and the integrated circuit can be planned in advance and thus integrated circuits having predetermined properties may be manufactured accordingly. According to this embodiment, the attachment process is controlled, particularly by means of a feedback control structure whose control variable is the determined distance, in response to the determined distance. As stated hereinbefore, attaching the integrated circuit to the substrate may be carried out by means of a thermode, which presses the integrated circuit to the substrate and applies heat for curing the material (e.g. an adhesive). Utilizing the determined distance between the integrated circuit and the substrate may allow to control the force, pressure and/or feed of the thermode such that, for instance, the force, pressure and/or feed of the thermode is increased until the pre-determined distance is reached.

The material may be treated in order to adjust its optical properties. The material may be colored or special particles may be added to the material. The particles may increase the amount of light scattering and/or the amount of light absorption.

If the substrate is transparent, a calibration of the inventive devices can be achieved utilizing a transparent reference substrate. The thickness of the substrate may be determined by pressing the reference substrate into a soft material, for instance, a resin, and by measuring the imprint of the resin.

The integrated circuit may comprise first electric contacts, which are in electric contact with second electric contacts of the substrate. Then, the picture may include an image of the first electric contacts being in contact with the second electric contacts. If so, it is possible to check if the first electric contacts (the contacts of the integrated circuit) reliably contact the second electric contacts (the contacts of the substrate). In this embodiment it is also be possible to check the desired distance, with which the integrated circuit should be spaced apart from the substrate, if a sufficient electric contact between the first contacts and the second contacts can be deduced from their image and structures of the integrated circuit are not or only hardly visible in the picture. Then, the integrated circuit reliably contacts the substrate and is still relatively far away from the substrate resulting in a relative small parasitic capacitance. Thus, it is possible in this embodiment to determine the correct attachment of the integrated circuit to the substrate by evaluating the image of the electric contacts shown in the picture and/or in the image data related to the picture, wherein a correct attachment is identified if the image of the contacts implies sufficient electric contact between the first and second contacts, and structures of the surface of a main body of the integrated circuit are not yet visible and/or visible with a certain contrast in the picture and/or in the image related to the picture. The surface of the main body of the integrated circuit faces towards the substrate.

If the picture also shows the image of the first and second contacts, then a correct position of the integrated circuit relative to the substrate may be identified. This may particularly be achieved in a relative simple manner, if the integrated circuit has four bumps which are ordered in a rectangular manner on the surface of the integrated circuit facing the substrate. All or some of the bumps may be contacts of the integrated circuit.

In one embodiment the inventive method comprises:

projecting an image on the integrated circuit through the substrate and the material;

taking a picture of the image projected on the integrated circuit through the substrate and the material;

evaluating the picture and/or image data related to the picture; and

determining the distance between the integrated circuit and the substrate in response to the evaluated picture and/or image data related to the picture.

Normally, the integrated circuit includes structures, which are visible in the picture. If, however, the integrated circuit does not have sufficient structures, then the picture of the image and/or the image data related to the picture of the image can be utilized for determining the distance between the substrate and the integrated circuit. The corresponding inventive device may then comprise projecting means configured to project an image on the integrated circuit through the substrate and the material; wherein the camera is configured to take a picture of the image projected on the integrated circuit; and wherein the evaluating means are configured to evaluate the picture and/or image data related to the picture, and to determine the distance between the integrated circuit and the substrate in response to the evaluated picture and/or image data related to the picture.

### BRIEF DESCRIPTION OF THE DRAWINGS

The invention will be described in greater detail hereinafter, by way of non-limiting examples, with reference to the embodiments shown in the drawings.

FIG. 1 is an integrated circuit attached to a substrate;

FIG. 2 illustrates the process of attaching the integrated circuit to the substrate;

FIG. 3 are pictures of the integrated circuit;

FIG. 4 is a diagram illustrating the relationship between light intensity and distance between the substrate and the integrated circuit; and

FIG. 5 is a device for evaluating pictures of the integrated circuit.

### DESCRIPTION OF EMBODIMENTS

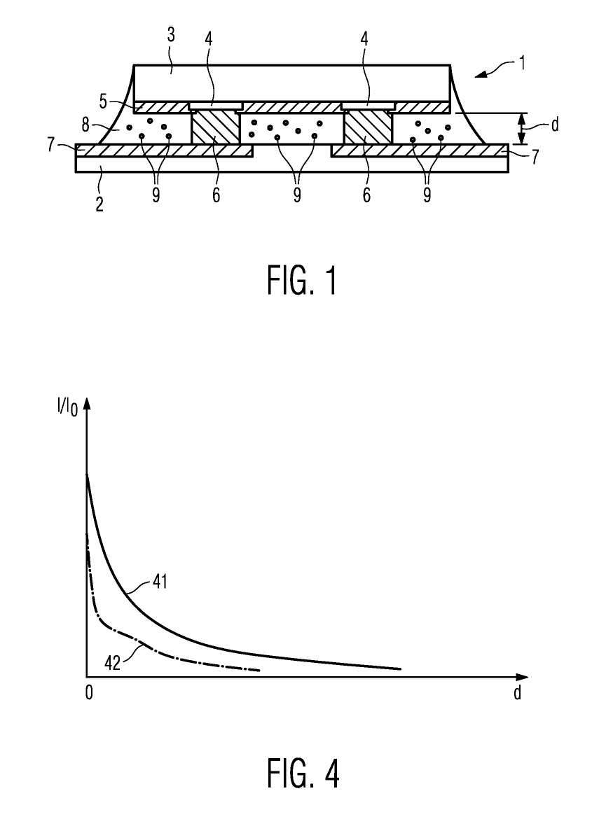

FIG. 1 shows an integrated circuit 1 attached to a substrate 2. The integrated circuit 1 may, for instance, be an integrated circuit for an RFID transponder and the substrate 2 may be a strap, via which contacts of the integrated circuits 1 are connected to an antenna of the RFID transponder.

According to this embodiment, the integrated circuit 1 comprises a main body 3 that includes the circuitry of the integrated circuit 1, connection pads 4, a passivation layer 5, and bumps 6. The substrate 2 comprises a metallization structure 7 applied on a first surface of the substrate 2. The metallization structure 7 may be made from aluminum and form contacts for connecting the bumps 6 to the antenna.

The passivation layer 5 is a sealing layer to prevent deterioration of the electric properties of the circuitry through chemical reaction, corrosion, or handling during a packaging process. In this embodiment, the material of the passivation layer 5 is silicon dioxide and forms a surface of the integrated circuit 1. The connection pads 4 may be made from aluminum and are accessible through holes of the passivation layer 5. The connection pads 4 are in electrical contact with the bumps 6 and the circuitry of the integrated circuit 1. The bumps 6 may be made from gold and are provided to be connected to the metallization structure 7.

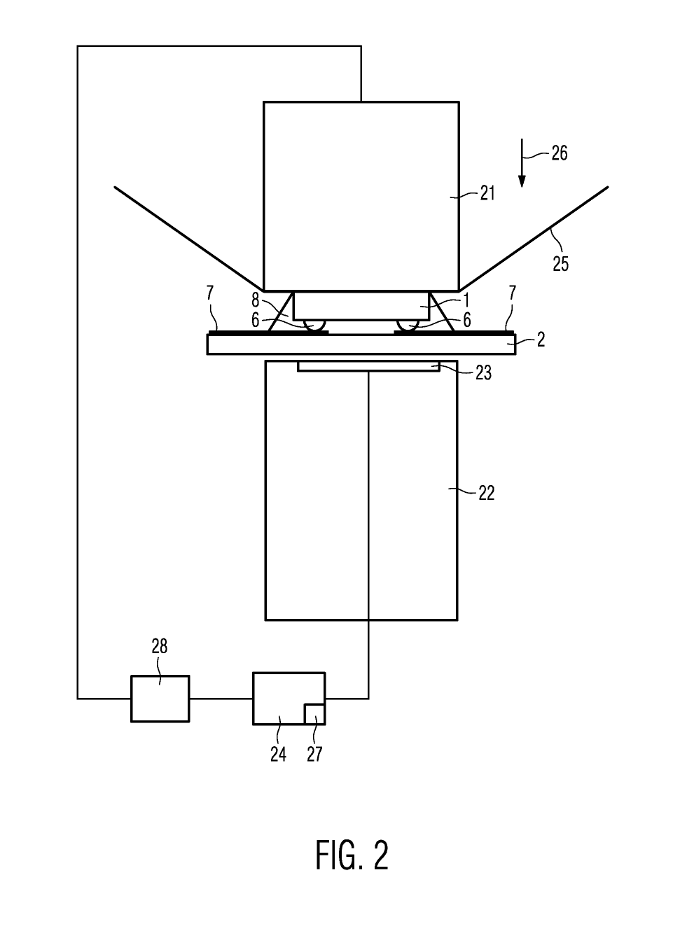

In order to attach the integrated circuit 1 with its surface defined by the passivation layer 5 to the substrate 2, an adhesive 8 is located between the integrated circuit 1 and the substrate 2. The adhesive 8 is, for instance, a non conductive paste (NCP) or an anisotropic conductive paste (ACP), which may also comprise small conductive particles. According to this embodiment, the integrated circuit 1 is attached to the substrate 2 by means of a thermode 21 depicted in FIG. 2.

Furthermore, the substrate 2 is placed on a base plate 22 with the surface vis-á-vis the metallization structure 7. On the surface comprising the metallization structure 7 vis-á-vis the base plate 22 the integrated circuit 1 including the adhesive 8 is located.

In this embodiment, the base plate 22 comprises a camera 23 connected to an evaluating device 24. The camera 23 is, for instance, a CCD sensor and is located in the base plate 22 such that it can take pictures from the surface of the integrated circuit 1 defined by its passivation layer 5 through the substrate 2 and through the adhesive 8. For a proper function of the camera 23, i.e. its ability to take such a picture, it is necessary that light can pass through the substrate 2. Thus, the substrate 2 is at least semi transparent. According to one embodiment, the substrate 2 is a relatively thin plastic foil made, for instance, from Polyethyleneterephthalate (PET).

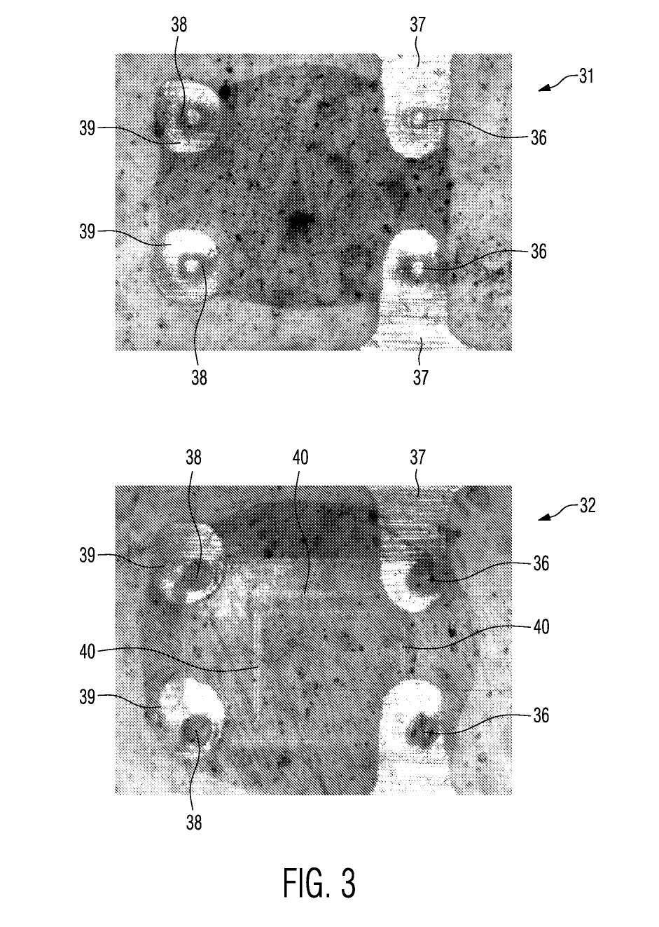

The thermode 21 comprises a planar surface, which contacts the integrated circuit 1 via a sheet of paper 25 at the surface facing away from the passivation layer 5. In order to bond the integrated circuit 1 to the substrate 2, the thermode 21 presses the integrated circuit 1 towards the substrate 2 (in the direction of the arrow 26). Due to the pressure or force applied to the integrated circuit 1 by the thermode 21, the adhesive 8, which has not been cured yet, is, inter alia, compressed such that the distance d between the integrated circuit 1 and the substrate 2 decreases. According to one embodiment, the camera 23 takes pictures 31, 32 of the integrated circuit 1 through the substrate 2 and the adhesive 8. FIG. 3 shows examples of these pictures 31, 32.

The substrate 2 and the adhesive 8 are at least semi transparent and absorb light emitted from the camera 23 for taking the pictures 31, 32 of the integrated circuit 1 through the substrate 2 and the adhesive 8. The absorption of light due to an optical layer may be described by the so-called Lambert law:

I=I₀e^{-ad}

wherein I₀ is the intensity of light entering the optical layer, I is the intensity of light leaving the optical layer, d is the thickness of the optical layer, and α is the absorption coefficient describing the amount of light the optical layer is absorbing. This theoretical relationship is illustrated by a graph 41 shown in FIG. 4. In practice, however, scattering of light, absorption of light by the integrated circuit 1, etc., may occur. Then, the relationship between the distance d and the intensity I of light may have to be determined empirically a priory and may be illustrated by a graph 42 of FIG. 4.

As mentioned above, the camera 23 takes the pictures 31, 32 during the attachment process in this embodiment. The pictures 31, 32 are particularly pictures of the surface of the main body 3 facing towards the substrate. Furthermore, the pictures 31, 32 show images 36 of the bumps 6 and images 37 of the metallization structure 7. In this embodiment, the integrated circuit 1 comprises two further bumps, whose images 38 are shown in the pictures 31, 32. The further bumps are auxiliary bumps not connected to the circuitry of the integrated circuit 1 and are supposed to contact a further metallization structure of the substrate, whose images 39 show in the pictures 31, 32. The bumps 6 and the auxiliary bumps may be arranged in a rectangular order.

According to one embodiment, the passivation layer 5, i.e. the surface of the main body 3 facing towards the substrate 2 comprises a structure. This structure may also be shown in the pictures 31, 32. The reference sign 40 denotes the image of the structure.

During the attachment process, the distance d between the integrated circuit 1 and the substrate 2 decreases. Furthermore, the absorption and/or scattering of light of the adhesive 8 is reduces as well. So, the smaller the distance d, the better the visibility of the structure of the integrated circuit 1. Additionally, the smaller the distance d, the more the bumps 6 and the auxiliary bumps are pressed into the metallization structure 7. Therefore, the contrast of the image 40 of the integrated circuit 1 structure and the contrast of the images 36, 38 of the bumps 6 and the auxiliary bumps increases or improves with decreasing distance d. This is evident from the picture 31, which shows the integrated circuit 1 at a distance d greater than the distance d when the picture 32 was taken. Therefore, the distance d between the integrated circuit 1 and the substrate 2 can be determined by evaluating the pictures 31, 32 and particularly by evaluating the contrast of the image 40 of the integrated circuit 1 structure and/or the images 36, 38 of the bumps 6 and the auxiliary bumps.

As mentioned hereinbefore, the camera 23 is connected to the evaluating device 24. According to one embodiment, the camera 23 transfers the image data related to the pictures 31, 32 to the evaluating device 24. The evaluating device 24 is configured to evaluate the image data, particularly the contrast of the images 36, 38, 40 shown in the pictures 31, 32 by, for instance, pattern recognition means. In response to the evaluation, the evaluating device 24 determines the actual distance d between the integrated circuit 1 and the substrate 2 and feeds information about the actual distance d to a control device 28. The control device 28 is connected and configured to control the thermode 21 in response to the determined distance d.

In a preferred embodiment, the control device 28 controls the thermode 21 such that it exerts pressure or force to the integrated circuit 1 until the distance d reaches a pre-defined distance d_{desired} by which the integrated circuit 1 shall be placed apart from the substrate 2. When the distance d between the integrated circuit 1 and the substrate 2 reaches the desired distance d_{desired}, then the control device 28 stops the thermode 21 and causes the thermode 21 to apply heat to the integrated circuit 1, in order to cure the adhesive 8.

In order to modify the optical properties of the adhesive 8, the adhesive 8 may be colored or may comprise pigments 9 added to the adhesive 8. The pigments 9 may absorb and/or scatter the light passing through the adhesive 8.

According to the attachment procedure described hereinbefore, the pictures 31, 32 are utilized to control the attachment procedure on line.

It is also possible to take a picture 31, 32 after the end of the attachment procedure in order to check the correct course of this procedure. In response to evaluating the picture 31, 32, parameters of the attachment procedure may be adjusted, particularly pressure, force and/or feed of the thermode 31.

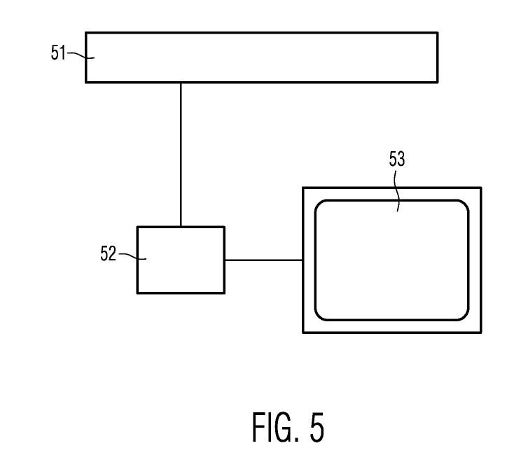

FIG. 5 shows a device suitable for taking and evaluating the pictures 31, 32. The device comprises a camera 51 similar to the camera 23 of FIG. 2 and an evaluating device 52 similar to the evaluating device 24 of FIG. 2. The light sensitive surface of the camera 51 has an appropriate size to accommodate the integrated circuit 1 attached to the substrate 2. For taking the pictures 31, 32 of the integrated circuit 1 through the substrate 2 and the adhesive 8, the camera 51 is brought to the surface of the substrate 2 vis-á-vis the integrated circuit 1 such that the light sensitive surface of the camera 51 is close to or touches this substrate surface. Light necessary for taking the picture 31, 32 may originate from a light source integrated into the camera 51. The light source is not explicitly shown in the figures.

After having taken the picture 31, 32 of the integrated circuit 1, the image data related to the picture 31, 32 are evaluated by the evaluating device 52 similar as described above for the evaluating device 24.

The evaluating device 52 is configured to determine the distance d between the integrated circuit 1 and the substrate 2. The distance d may be displayed on a display 53 connected to the evaluating device 52. The evaluating device 52 may also be configured to compare the determined distance d with the desired distance d_{desired}. If the determined distance d equals the desired distance d_{desired} within a certain tolerance, then the evaluating device 52 may be configured to display a message on the display 53 that the integrated circuit 1 is spaced apart from the substrate 2 within the desired distance.

The result of the evaluation of the distance d may be used to adjust parameters for the attachment process of further integrated circuits 1 on respective substrates 2, such as adjusting the force, pressure, feed and/or temperature of the thermode 21.

It is also imaginable that the correct position of the integrated circuit 1 relative to the substrate 2 is evaluated by evaluating the pictures 31, 32 and/or the related image data. This can be achieved by evaluating the images 36, 38 of the bumps 6 and the auxiliary bumps and the images 37, 39 of the metallization structure 37, 39.

It is also imaginable that a person not shown in the Figs. manually evaluates the pictures 31, 32. Then, the pictures 31, 32 may be displayed on the display 53.

It is also imaginable to project an image to the integrated circuit surface facing towards the substrate 2 and to take a picture of this image through the substrate 2 and the adhesive 8. Then, the picture of the image can be used to determine the distance d between the integrated circuit 1 and the substrate 2.

The described method and device are particularly useful when assembling RFID devices working in the LF (low frequency), HF (High frequency) or UHF (ultra high frequency) domain.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A method of determining the distance between an integrated circuit and a substrate, comprising the steps of:
taking a picture of an integrated circuit, which is attached to an at least semi transparent substrate, wherein an at least semi transparent material, particularly an at least semi transparent adhesive, is located between the integrated circuit and the substrate, and wherein the picture of the integrated circuit is taken through the substrate and the material;
evaluating the picture and/or image data related to the picture; and
determining the distance between the integrated circuit and the substrate in response to the evaluated picture and/or image data related to the picture.

2. The method of claim 1, comprising
evaluating the picture and/or image data related to the picture by evaluating the contrast of structures showing in the picture; the structure showing in the picture being related to structures of the integrated circuit; and/or
evaluating the picture and/or the image data related to the picture by means of pattern recognition.

3. The method of claim 1, wherein the integrated circuit comprises first electric contacts which are in electric contact with second electric contacts of the substrate and the picture includes an image of the first electric contacts being in contact with the second electric contacts, the method particularly further comprising evaluating the position of the integrated circuit relative to the substrate by evaluating the image of the first electric contacts being in contact with the second electric contacts.

4. The method of claim 1, further comprising controlling and adjusting a process of connecting the integrated circuit to the substrate in response to the determined distance, particularly such that the distance between the integrated circuit and the substrate has a pre-determined distance at the end of the process.

5. The method of claim 1, further comprising
projecting an image on the integrated circuit through the substrate and the material;
taking a picture of the image projected on the integrated circuit through the substrate and the material;
evaluating the picture and/or image data related to the picture; and
determining the distance between the integrated circuit and the substrate in response to the evaluated picture and/or image data related to the picture.

6. A device for determining the distance between an integrated circuit and a substrate, comprising:
a camera; and
evaluating means configured to evaluate a picture and/or image data related to the picture, wherein the picture is taken by the camera and is a picture of an integrated circuit, which is attached to an at least semi transparent substrate; wherein an at least semi transparent material is located between the integrated circuit and the substrate; such that the picture of the integrated circuit is taken through the substrate and the material; and wherein the evaluating means are configured to determine the distance between the integrated circuit and the substrate in response to the evaluated picture and/or image data related to the picture.

7. The device of claim 6, wherein the evaluating means
are configured to evaluate the picture and/or image data related to the picture by evaluating the contrast of structures showing in the picture; the structure showing in the picture being related to structures of the integrated circuit; and
comprise pattern recognition means configured to evaluate the picture and/or the image data related to the picture by means of pattern recognition.

8. The device of claim 6, wherein the integrated circuit comprises first electric contacts which are in electric contact with second electric contacts of the substrate and the picture includes an image of the first electric contacts being in contact with the second electric contacts; wherein the evaluating means are configured to evaluate the position of the integrated circuit relative to the substrate by evaluating the image of the first electric contacts being in contact with the second electric contacts.

9. The device of claim 6, further comprising a control device configured to control and to adjust a process of connecting the integrated circuit to the substrate in response to the determined distance, particularly such that the distance between the integrated circuit and the substrate has a pre-determined distance at the end of the process.

10. The device of claim 6, further comprising projecting means configured to project an image on the integrated circuit through the substrate and the material; wherein the camera is configured to take a picture of the image projected on the integrated circuit; and wherein the evaluating means are configured to evaluate the picture and/or image data related to the picture, and to determine the distance between the integrated circuit and the substrate in response to the evaluated picture and/or image data related to the picture.
